(19) United States
(12) Patent Application Publication
(10) Pub. No.: US 2019/0072728 A1
(43) Pub. Date: Mar. 7, 2019

(54) UNI-BODY DESIGN FIBER OPTIC CASSETTES TO FACILITATE RAPID DEPLOYMENT IN VARIED CONFIGURATIONS AND METHOD TO PRODUCE SAME

(71) Applicant: Idania Corporation, Medway, MA (US)

(72) Inventor: Steven Rolfe, Seekonk, MA (US)

(21) Appl. No.: 15/910,619

(22) Filed: Mar. 2, 2018

Related U.S. Application Data
(60) Provisional application No. 62/466,944, filed on Mar. 3, 2017.

(51) Int. Cl. G02B 6/38; G02B 6/44

(52) U.S. Cl. CPC G02B 6/3893; G02B 6/3897; G02B 6/4471; G02B 6/4453

(57) ABSTRACT

The present invention relates to cassettes or holders in which fiber-optic cables and wires are connected, and which cassette is designed to mount into a predesigned, pre-configured electronics/equipment storage rack. The fiber optic cassette as commonly used in Data Centers and other facilities for making connections between two or more fiber-optic wires that can be rapidly assembled in a vast array of configurations economically and without additional tooling.

### CROSS-REFERENCE TO RELATED APPLICATIONS

This application claims priority from U.S. Provisional Patent Application No. 62/466,944 titled “UNI-BODY DESIGN FIBER OPTIC CASSETTES TO FACILITATE RAPID DEPLOYMENT IN VARIED CONFIGURATIONS AND METHOD TO PRODUCE SAME” filed on Mar. 3, 2017 and which is incorporated fully herein by reference.

### FIELD OF THE INVENTION

The present invention relates to cassettes or holders in which fiber-optic cables and wires are connected, in which cassette is designed to mount into a predesigned, pre-configured electronics/equipment storage rack.

### BACKGROUND OF THE INVENTION

There exists a need for a design of a Fiber Optic Cassette as commonly used in Data Centers and other facilities for making connections between 2 or more fiber-optic wires that can be rapidly assembled in a vast array of configurations economically and without additional tooling.

There has long been a need for fiber connectivity using industry standard connectors such as MPT, LC, LC/APC, or SC fiber ports to MTP/MPO backbone trunks and other variations, that can quickly adapt to rapidly changing landscape of demands and functionality of myriad end user requirements. Existing product cannot fulfill this criteria.

Currently, systems offered on the market are offered in pre-built configurations adding to requiring specific tooling and molding cycles which manifests in increased production costs, exposure to overstocked inventory and overly long delivery dates.

Currently, existing product requires proprietary standard 19 inch rack cabinets to secure the cassettes.

Accordingly, what is needed is a fiber-optic cassette wherein the product design and the manufacturing thereof provides for a solution to reduce manufacturing costs, over inventory exposure, and provide a method of rapid deployment of both standard and custom configurations of copper and fiber connectivity.

### SUMMARY OF THE PREFERRED EMBODIMENT

The present invention relates to a fiber-optic cassette product design and the manufacturing thereof which provides for a solution to reduce manufacturing costs, over inventory exposure, and provide a method of rapid deployment of both standard and custom configurations of copper and fiber connectivity.

The purpose of the uni-body Series of Fiber Optic Cassettes according to the present invention is to provide a universal body that can adapt to an array of configurations by using snap in configuration units and connector units. In this way, a purveyor can maintain a large inventory of the Uni-Body cassette body and simply snap in the pieces required to fill any requested configuration to fulfill customer requirements on a per order basis. It is this method of both design and manufacture that will yield a significant advantages in the market place by providing the following solutions:

Only one mold and tooling is required to accommodate many configurations. At present, the configurations require tooling and mold making as well as injection production cycles to address each line of end product. The Uni-body series of fiber optic cassettes according to the present invention greatly reduces production cost while minimizing over runs and delivery time.

The snap in modules not only can be produced on the same mold (for instance six of the most common configurations can be produced with each Uni-Body injected) but also can be 3D printed to facilitate rapid deployment of custom and as yet undeveloped components and configurations.

The design of the Uni-Body universal latch recess to secure the cassette to a rack or similar structure may be applied with a variety of latches, spring clips, pins, etc. so as to accommodate various cabinet configurations, thus broadening the range of sales and help defray obsolescence.

The product according to the present invention incorporates three main parts that comprise the Uni-Boy Design and Manufacturing of Fiber Optic Cassettes. They are:

The Uni-Body Module itself;

The Configuration Snap In connector Modules; and

The Universal Recess/Latch Mounts.

The Uni-body Series of Fiber Optic Cassettes according to the present invention provide a new design and method of assembly that requires no additional tooling to meet various configurations. This is new and distinct in that a separate cassette does not need to be tooled and produced to meet a specific configuration requirement.

The Uni-body Series of Fiber Optic Cassette can support two Networks in one cassette due to the Left, Right, or Both Trunk (MPT preferred) options. This is accomplished by supplying a left and right output cavity with optimal radius walls of different elevations a truly distinct methodology.

The Uni-body Series of Fiber Optic Cassette can support both copper and fiber medium either concurrently or dedicated implementation. This is accomplished by the unique and distinct innate ability in the flexibility of the open architecture of the design.

The Uni-body Series of Fiber Optic Cassettes use a unique Universal Recess/Latch Cavity allowing the unit to be fastened in a number of ways, including, blocks, spring clips, screws, and other fasteners.

The Uni-body Series of Fiber Optic Cassette snap in modules lend to the unique ability to be 3D printed to facilitate rapid deployment of custom and as yet undeveloped components and configurations.

The Uni-body Series of Fiber Optic Cassettes are not restricted to use in a standard case, and can in fact be fastened to any flat surface such as a shelf, wall, ceiling, under desks, etc.

It is important to note that the present invention is not intended to be limited to a device or method which must satisfy one or more of any stated or implied objects or features of the invention. It is also important to note that the present invention is not limited to the preferred, exemplary, or primary embodiment(s) described herein. Modifications and substitutions by one of ordinary skill in the art are considered to be within the scope of the present invention, which is not to be limited except by the allowed claims.

### BRIEF DESCRIPTION OF THE DRAWINGS

These and other features and advantages of the present invention will be better understood by reading the following detailed description, taken together with the drawings wherein:

FIG. 1 is plan view of one embodiment of the fiber-optic cassette according to the present invention;

FIGS. 2A-2C are plan views of various snap in fiber connector modules that may be inserted in the fiber-optic cassette in accordance with one feature of the present invention;

FIGS. 3A-3F are plan views of the universal latch recess on the fiber-optic cassette utilized to secure the cassette with a variety of latches and spring clips according to the present invention; and

FIGS. 4A-4F are plan views of the fiber-optic cassette of FIG. 1 with a further variety of snap in fiber connector modules.

### DETAILED DESCRIPTION OF THE PREFERRED EMBODIMENTS

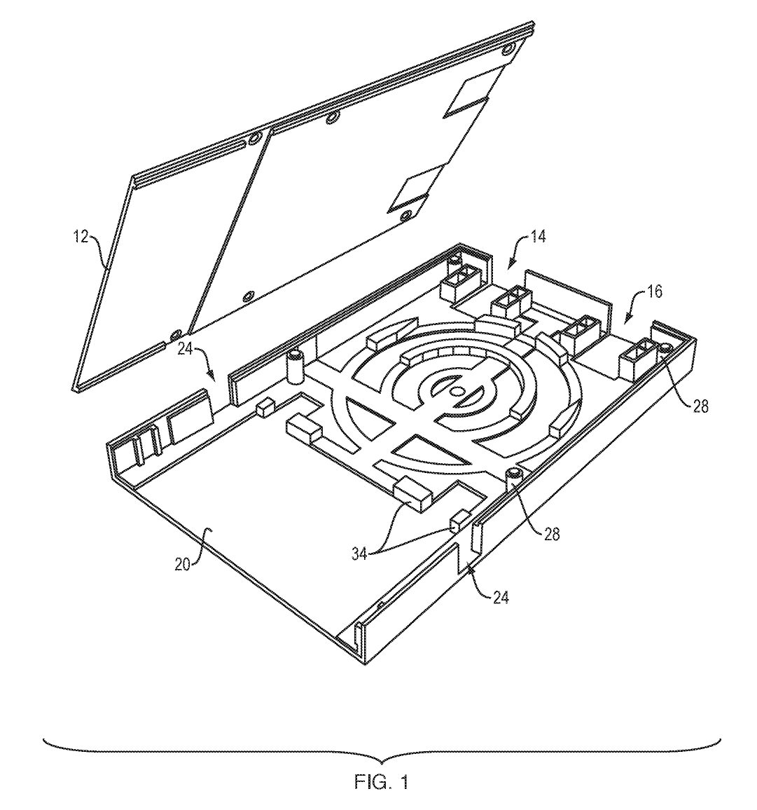

The present invention features a uni-body module 11 comprised of a bottom portion 10 and cover portion 12, FIG. 1. In the preferred embodiment, the module is constructed from and ABS plastic material, although other plastic, polymers, and even metal could be utilized. The main features are:

Dual MPT Trunk cavities. Either left 14, right 16, or both (effectively supporting two networks in one cassette) trunk cavities are made available for variable back end configurations. Clip Blocks 34 FIG. 1 are used to secure the snap in modules 18. The universal latch recess 24 secures the cassette with a variety of latches and spring clips 26, pins, etc. An example of the latches and spring clips useable with the cassette of the present invention are disclosed in co-pending U.S. patent application Ser. No. 15/910,649 filed Mar. 2, 2018 and entitled “Method Of Securing Fiber Optic Cassettes Allowing For Tool-Less Insertion And Extraction” incorporated fully herein by reference. Boss 28 are used to attach the cover 12 to the base 10 with fasteners such as screws 30, rivets, push clips, etc.

Optimal Radius Guides with a differential in elevations provide the ability to utilize more than one output whip/MPT trunk. Cover 12 incorporates recess areas 6 which provide relief for tops of internal components assuring of minimal product height.

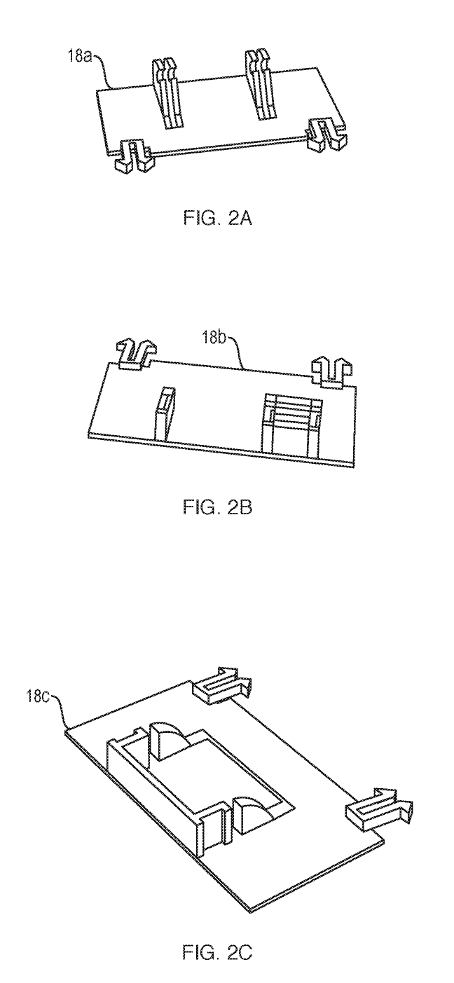

1. The configuration snap in modules 18 are created in a number of configurations, some in standard designs, and they also may be customized. As shown in FIGS. 2A-2C a standard snap in module design is shown that supports 2 quad adapters and a label panel. The preferred material is ABS plastic, although other plastic, polymers, and even metal could be utilized. The main features of the snap in module are a base 19, split snap connectors 21, component supports 23 and a label plate 25.

The design of the cassette bottom portion 10 uses a recess 24 on each side to act as a receiver to lock the finished cassette 11 in place. A support latch can be produced in an array of variations so as to accommodate various cabinet configurations, thus broadening the range of sales and help defray obsolescence. The preferred material is ABS plastic, although other plastic, polymers, and even metal could be utilized.

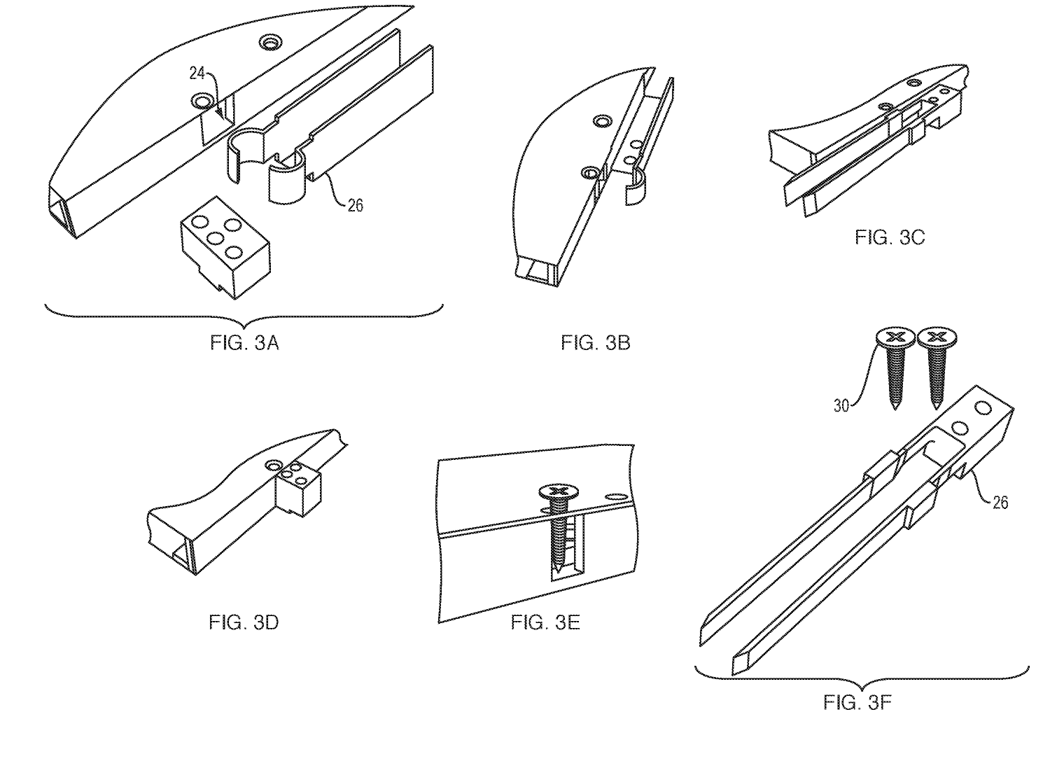

The Universal recess 24 is a simple rectangular cavity on each side of the case. Samples of usage are illustrated as follows in FIGS. 3A-3F and include: a universal recess cavity 24; a spring metal retainer clip 26; and ABS plastic retainer clip 27; a plastic simple lock block 29; and standard screws 30.

In addition to the specified parts as described above, industry standard connection components will populate the uni-body fiber optic cassette 11. As outlined, the components necessary for construction are: the Uni-Body Module bottom or base 10; the configuration snap in modules 18, 20, 22, 38 and the Uni-Body cover 12

The above components can be manufactured in advance by way of injection molding. ABS is the preferred material, however, polymers or even metal can serve as a substitute.

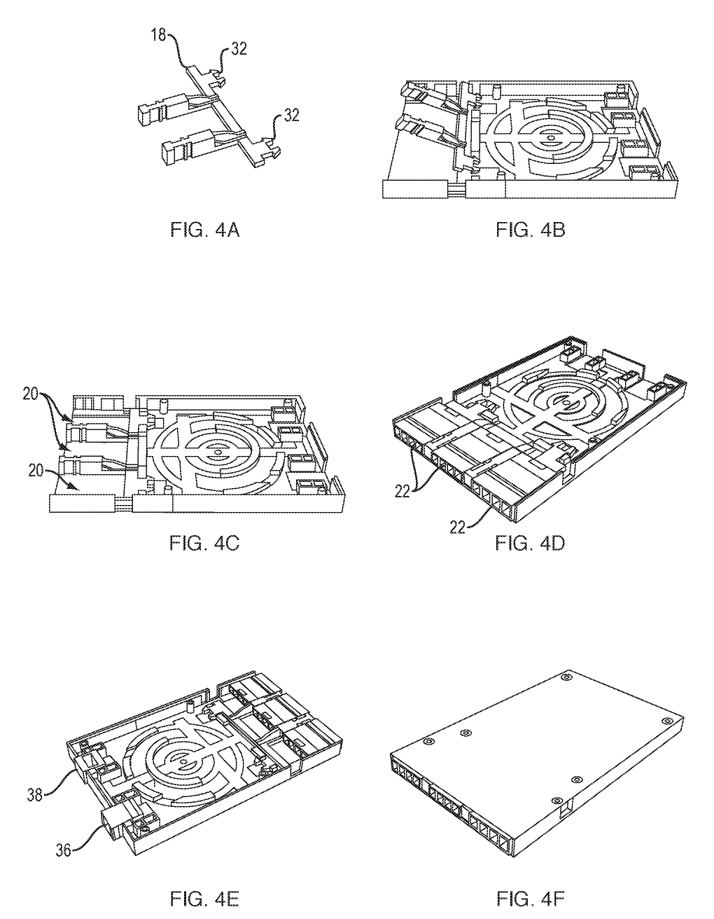

Assembly of the cassette 11 is shown in connection with FIGS. 4A-4F. Step 1, FIG. 4A, select snap in module 18 to suit required configuration. In this example, the assembly is to solve for a configuration that consists of 3 units of Quad LC connectors 22 FIG. 4D in the front to a single MTP connector 36 FIG. 4E on the back of the cassette

The split snap connectors 32 of the snap in module 18 are inserted behind the clip blocks 34 of the Uni-Body base 10, FIG. 4B. The snap in module 18 is pushed down into the base 10 until it “clicks” into place, FIG. 4C.

The Uni-Body Fiber Optic Cassette is now ready for population. To meet the desired configuration, three quad LC connectors 22 are snapped into place, FIG. 4D. Next, to meet the desired configuration, an MPT connector 36 is inserted and snapped into place into the desired side on the rear of the cassette, and a dust plug 38 into the unused place, FIG. 4E.

The cover 12 is next placed on the on cassette body unit 10 and secured with fasteners such as screws, rivets, split pins, glue, or other means, FIG. 4F. The Uni-Body Fiber Optic Cassette is now ready for testing, packaging and shipping.

The present invention is not intended to be limited to a device or method which must satisfy one or more of any stated or implied objects or features of the invention. It is also important to note that the present invention is not limited to the preferred, exemplary, or primary embodiment(s) described herein.

Modifications and substitutions by one of ordinary skill in the art are considered to be within the scope of the present invention, which is not to be limited except by the allowed claims.

1. A universal fiber-optic connector cassette, comprising:
a bottom portion and a cover portion, the bottom portion including a snap in module interconnection region and a network connector interconnection region, said snap in module interconnection region including a plurality of clip blocks, configured to releasably secure said snap in module to said bottom portion;
a snap in module including a plurality of clips, said clips configured for releasably interconnecting with at least 2 clip blocks of said plurality of clip blocks disposed on said bottom portion of said cassette;
said snap in module further including a plurality of connector interconnection regions, each of said connector interconnection regions configured for interconnecting with a wire connector selected from one or more wire connector configurations;
said network interconnection region on said bottom portion of said universal fiber-optic connector cassette including a plurality of network interconnection regions configured for interconnecting with one or more network wire connectors selected from a plurality of connector wire connector configurations;
first and second universal latch recesses, said first universal latch recess disposed on a first side of said universal fiber-optic connector cassette and said second universal latch recess disposed on a second side of said universal fiber-optic connector cassette, said first and second universal latch recesses configured for securing said universal fiber-optic connector cassette in position utilizing one or more universal fiber-optic connector cassette securing device; and
said cover portion sized and configured for being disposed over said bottom portion, said cover portion including a plurality of recess areas providing additional room for the top of one or more internal connector components disposed in said bottom portion.

2. The universal fiber-optic connector cassette of claim 1 further including one or more universal fiber-optic connector cassette securing devices, configured for releasably securing said fiber-optic cassette to a surface, said one or more universal fiber-optic connector cassette securing devices comprising:
a retainer device configured for being secured to a surface and including a first side and a second side, said second side being a mirror-image of said first side, said first and second sides each having a predetermined length, said second side coupled a spaced distance apart from said first side by a connector element which extends between said first and second side a length which is less than said predetermined length of said first and second sides, each of said first and second sides including a first end and a second end, said second end of each of said first and second sides of said securing device including an arcuately shaped protrusion configured for releasably engaging with said first and second universal latch recesses disposed on said first and second sides of said fiber-optic cassette.

3. The universal fiber-optic connector cassette of claim 2, wherein said connector element includes one or more holes allowing said retainer device to be secured to a surface.

4. The universal fiber-optic connector cassette of claim 2, wherein said retainer device is made of a spring metal.

5. The universal fiber-optic connector cassette of claim 2, wherein said retainer device is made of ABS Plastic.
